(19) United States
(12) Patent Application Publication
(10) Pub. No.: US 2017/0099821 A1
(43) Pub. Date: Apr. 13, 2017

(54) ANGLE BAR FISHING LURE

(71) Applicant: Robert A. Locker, Bozeman, MT (US)

(72) Inventor: Robert A. Locker, Bozeman, MT (US)

(21) Appl. No.: 14/880,386

(22) Filed: Oct. 12, 2015

(51) Int. Cl. A01K 85/08

(52) U.S. Cl. CPC A01K 85/08

(57) ABSTRACT

A lure with front and rear sections parallel, and an angled mid-section which, causes rotating reversable wounded baitfish action as it settles, and an enticing wobble that changes as it is retrieved at various speeds.

### FIELD OF THE INVENTION

The present invention relates to an equal ended fishing lure with a center angle portion joining the two parallel ends and, more particularly, to provide a pivoting and reversible fluttering action as it settles, and a wobbling action as it is retrieved.

### BACKGROUND OF THE INVENTION

The majority of artificial fishing lures are designed to emulate bait fish or minnows, the prey of most game fish. This emulation consist of both sight (appearance and motion) and sound, in the form of vibrations detectable to fish. Other lures generally use the front portion (of the lure) to create the action. In the case of plugs many have a lip or angled portion (at the front) to create water resistance and the movement of the lure itself.

Spinner lures such as the Mepps Aglia, Blue Fox, Panther Martin, and Roostertail use a blade rotating around a wire spindle. These lures often create vibration that is audible to fish, but do little for the appearance and action that is attractive to them.

Large spinner blades (often in tandem) with enticements, such as rubber strands or worm or crayfish shapes, which camouflage the hook and are effective for largemouth bass, a popular segment of the fishing world. Vibration is the key with the artificial rubber or plastic enticements a strong contributor to this lure's success.

Wobbling spoons create a predicable movement and a degree of “sight appeal”, but have little audible vibration.

Plugs, such as the Rapala and Rebel often have a good visual appeal, and sometimes effective vibrations, but have limited ability to create erratic movement.

Another style of metal lure uses the ability to cast a reasonable distance as its major asset. An example of that would be the “Kastmaster” by Acme lure company.

Fish are particularly attracted to the sight and sounds created by wounded minnows or other bait fish and none of the above types of lures are particularly well adapted to creating these effects.

While each of the different types of artificial lures (spinners, plugs, wobbling spoons) have examples that appeal in either sight, movement, or vibration, none is able to create a combination of the three and also provide sights and sounds similar to wounded baitfish.

There has been a rapid expansion recently in the sport of ice fishing, as well as the technique of vertical jigging. Much of these activities use bait and sinkers to get to the level at which the game fish are holding.

Few of the available artificial lures were designed for producing actions attractive to fish when limited (horizontally) to the area directly under the ice or boat. They are designed to use water resistance against the front end of the plug, spoon, or spinner bait to create the action or vibration. To expect them to perform well, in a mode for which they were not designed, is not realistic.

Vertical jigging lends itself to the use of live baits such as worms, minnows and leaches etc., but is limited in the ability to cast a distance from a boat, settle to the bottom, and slowly worked back to the angler. It also requires frequent re-baiting, and is limited to the supply and cost of such baits available in the area and type of water the angler is fishing.

The Kastmaster has the weight to cast to the fish, but has little attractive motion, or vibration, to attract game fish like the angle bar fishing lure.

Finally, there is a lure that is balanced front to back and uses the center portion to create the water resistance. If follows that this type of lure has a much wider range of actions and vibrations that would more closely resemble a bait fish in trouble. This is also true when used in areas where there is water movement or current as in a stream, This is further true when jigged vertically and raised, then allowed to drift downward letting the lure essentially create its own varied actions as it settles in the water column.

### SUMMARY OF THE INVENTION

In accordance with the present invention, there is provided a lure with wounded baitfish action as it settles, and an enticing wobble as it is retrieved at various speeds.

It would be advantageous to provide a fishing lure that has equal front and rear portions that have identical shape and surface area.

It would also be advantageous to provide a lure that has different angles for the center portion.

It would further be advantageous to provide a lure which is made in different size, thickness and weight, creating different crippled bait fish actions.

It would be further advantageous to create a small thin lure that would allow fly fishermen to project the lure using the weight of the line.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side view of an angle bar fishing lure;

FIG. 2 is a top view of an angle bar fishing lure;

FIG. 3 is a front view of an angle bar fishing lure;

FIG. 4 is a 3-d view view of an angle bar fishing lure;

FIG. 5 is a 3-d veiw view of an angle bar fishing lure body;

FIG. 6 is a side+180 view of an angle bar fishing lure in free fall; and

FIG. 7 is a side view of an angle bar fishing that is of thin material which adapts to fly fishing methods.

For purposes of clarity and brevity, like elements and components will bear the same designations and numbering throughout the Figures.

### DESCRIPTION OF THE PREFERRED EMBODIMENT

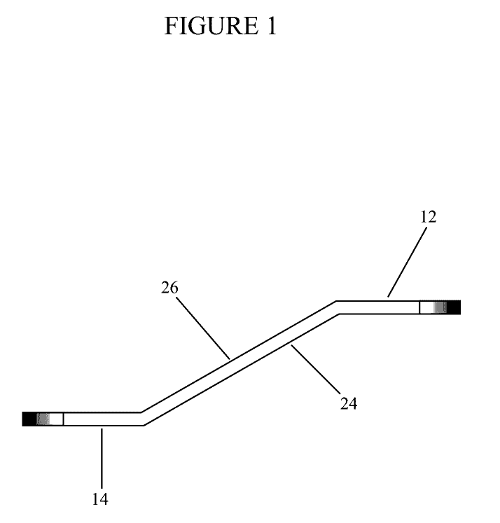

FIG. 1 is a side view of an angle bar fishing lure. There are several elements that separate the performance of this lure from any of the others.

First of all the swivel 18 up front makes all of the actions possible. The angled mid-section 24 with equal front section 12 and rear section 14 allows this lure to be totally balanced when pressure is released from the front (the line is slacked) which creates a water resistance that causes the lure to rotate and wobble like nothing else available. If the lure is allowed to free fall it will switch from the front to the back rotation and appear to a hungry predictor fish as a bait fish in trouble and easy prey. Depending on the thickness and weight of the lure it can sink slowly and very tantalizingly, or get to the depth at which the fish are feeding, very quickly. The three parts of the lure body 10 (the flat portions of angled mid-section 24. front section 12 and rear section 14) are in the same plane, creating a high degree of resistance in the water.

Take some time to fully analyze why this is unique and more effective than any other type of lures that has been created and widely accepted.

The following are the five basic types of fishing lures that are widely used and catch fish.

First is the spoon, which is designed to be moved forward either by retrieving or trolling the lure. There is the spinner blade lure, which has a high degree of vibration appeal, but little erratic movement. Then comes the plug which often has a lip at the front. Again the appeal is largely the vibration, but also often has the look of an actual bait fish. But, the missing element again, is this bait fish vulnerable?

The fourth type of lure is the jig. Often it has a realistic look of a bait fish and, depending on the detail offered, can fool a reasonable number of fish.

I will add a fifth type of lure which is the fly, used with a fly rod. In this form of fishing the weight of the line is used to cast the fly, not the weight of the fly or lure itself. This angle bar lure will be produced in very thin and therefor light weight small sizes, a “fly-lure” if you will. The more the weight is reduced the more action is created by the unique balanced design and the longer it will stay at a relatively shallow depth, which is necessary in most stream fishing. When used in water with current the lure will rotate, spin and slide without any effort by the fly fisherman, just the water movement, and the resistance it creates on various elements of the lure.

None of these existing five lures or methods have the overall appeal, variety of actions, and versatility of the angle bar lure concept. It creates is own action when allowed to drift erratically in a stream for trout or steelhead and salmon. In a vertical jigging application it is so life-like and full of attractive vibrations that it is far and away the most effective lure in this application.

To cast or troll at various speeds, the action changes dramatically, and gives the angler the entire range of action necessary to catch a wide variety of fish, from panfish to tarpon, . . . to tarpon, billfish and tuna.

This lure adds another dimension, that makes it more productive than the other types and styles of artificial fishing lures.

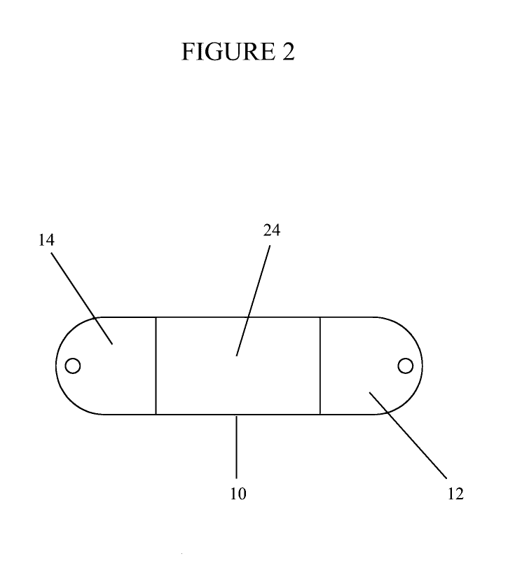

FIG. 2 is a top view of an angle bar fishing lure. This illustrates the approximate surface area of the front section 12, the rear section 14 and the angled mid-section 24. The key to many of the unique and varied movements relates to the angled mid-section 24 as it is in contact with the resistance of the water column. If allowed to settle, as in vertical jigging, the resistance will cause the lure body 10 to flip over (eased by the swivel 18 and its low resistance allowing freedom of motion). When it rotates 180 degrees the angled mid-section 24 creates a totally different direction of resistance, causing an opposite movement. By changing the angle of connection to the front section 12 and rear section 14, different moments and actions will be created, which will appeal to different types of gamefish depending on their feeding habits.

The size and thickness of the lure body 10 will dictate the distance the lure may be cast with traditional, bait casting or spinning methods. As an illustration, the smaller sizes can be made with average thickness which will provide ample casting distance for ultra-light spinning applications commonly used for small species such as yellow perch, crappies, and bluegills, but equally effective for gamefish such as trout, steelhead, walleyes and northern pike which also feed on small bait fish and minnows.

Larger and thicker sizes are very attractive to many larger salt water species such as ling cod, salmon, dorado, bonito, and halibut, while allowing a faster rate of sink or greater distance of casting, for those species the occupy significant depths or feed well away from a boat and spook easily in clear water.

Yet another element often need for truly large fish such as tarpon, Yellow-fin tuna, marlin and sail-fish requires that the lure to be cast long distances from the boat. This lure can be produced is sizes and weights that permit long distance casts, yet, when allow to free fall, produces lifelike injured bait fish actions unlike any other artificial lure. Before, these species were normally taken using live bait, and trolled or fished from a kite, a substantial distance from the boat.

I can't emphasize enough how this opens up another dimension to catch these sought-after species, using an artificial lure.

Yet, by using very small lure body 10 sizes and thin material, it can also be very effectively used with fly rod techniques, where the weight of the line is used to deliver the fly (or in this case the “fly-lure”) not the weight of the lure itself. This opens up an entirely undiscovered method of enticing trout, and steelhead to take the lure using fly fishing equipment. This specific but very avid and addictive group of anglers will soon be experiencing an entirely new opportunity to pursue these desirable species in stream situations.

In these very thin and small lure body 10 sizes this lure will be extra sensitive to the movement caused by the lure drifting with the current, which is often variable as it passes through various depths of stream flow. This, in itself, is reason enough to allow the claims requested by the inventor for the angle bar fishing lure.

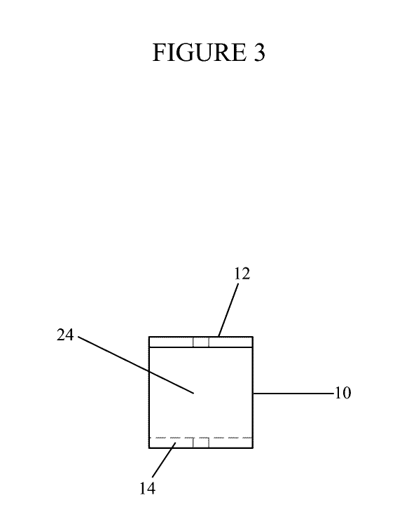

FIG. 3 is a front view of the lure body 10 by itself. In typical trolling or cast and retrieve situations this shows how the resistance to the angled mid-section 24 caused by the water will cause the lure to wobble from side to side. In fairly rapid retrieve or trolling speeds, the lure will create vibration sounds which are transmitted to the fish though their lateral lines and emulate the sound created struggling bait fish.

At very slow speeds the side to side movement will be increased, causing a more “sight related” enticement to game fish, that of a minnow in trouble.

When the rod tip is raised and then dropped, creating slack in the fishing line, the movement created ads an enticing motion as the lure body 10 rotates over to the other side and the lure swivels or rotates. All I can say is “keep a good grip on your rod”.

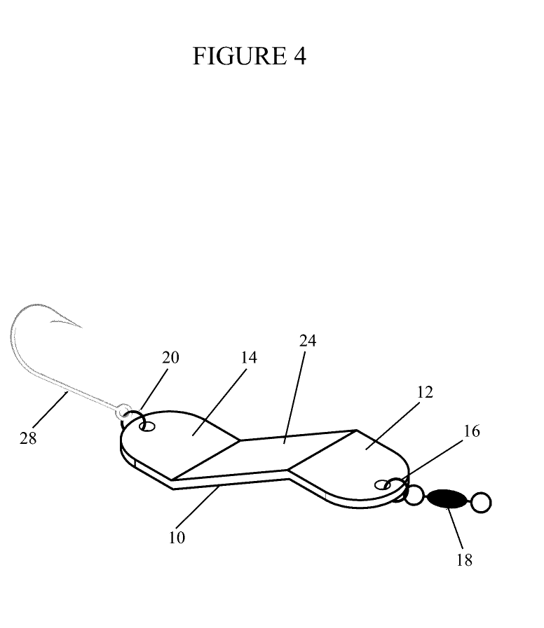

FIG. 4 is 3-dimensional view of the lure complete with front split ring 16, swivel 18, rear split ring 20 and hook 28. The hooks can be of single, double, or treble design. In the small sizes we have found a treble hook 28 coated in fluorescent orange to be very effective, especially for trout, steelhead, yellow perch and walleyes.

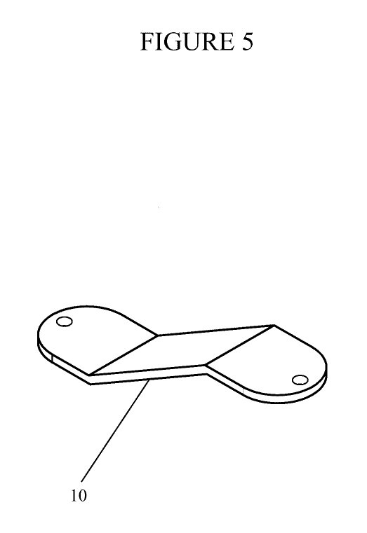

FIG. 5 is a 3-dimensional view of the lure body 10 alone, for more complete ease of illustration. I must again emphasize how the adaptation of a swivel 18, coupled with the effects caused by the angled mid-section 24 put an entirely new and extremely effective fishing lure design and function in the hands of the angler.

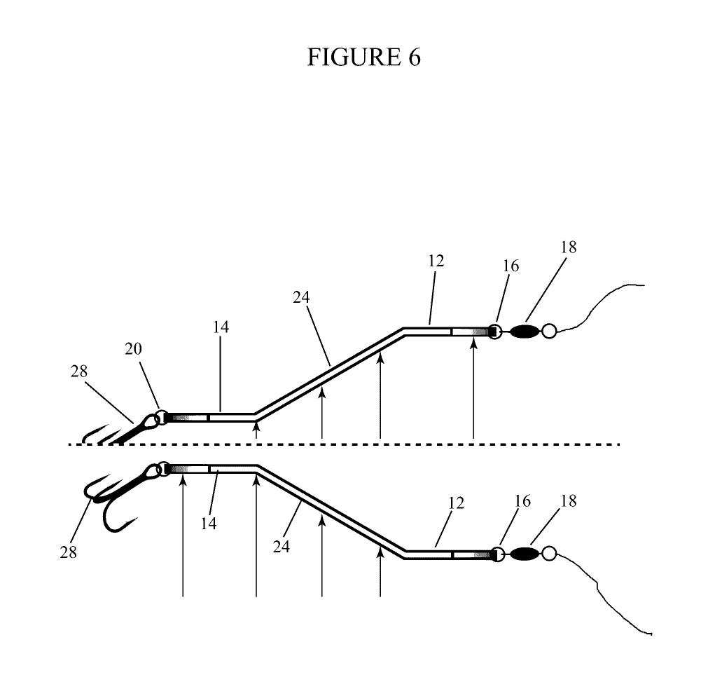

FIG. 6 shows how the water column is displaced when the lure body 10 is in position 1 (above the dotted line). The line is slack, allowing the angle bar fishing lure to settle of its own will. Position 2 (below the dotted line) illustrates its orientation after the lure naturally rotates 180 degrees.

Let's get technical. Position 1 results in the front section 12 and angled mid-section 24 (about ¾ of the lure body 10) needing to displace the water as the weight of the lure causes it to sink. The rate of sink and the degree of movement will depend on the weight of the lure including the front split ring 16 and swivel 18, the rear split ring 20, hook 28, and any clip on enticements that may be added.

As the pressure is released to the sides, it creates a vibration audible to game fish. The swivel 18 will allow the lure to rotate as the pressure builds causing in to “flip over” to position 2.

You can see that the majority of the pressure is now shifted to the rear section 14 and the angled mid-section 24 of the lure, creating a totally erratic action that certainly seems to the fish like and injured minnow and an easy meal. As the lure settles this prossess will be repeated with the pressure switching back to the front section 12, and “back again”

This should help you understand why this lure is so productive and has different and irresistible actions than the other 5 types of lure eluded to in FIG. 1 descriptions.

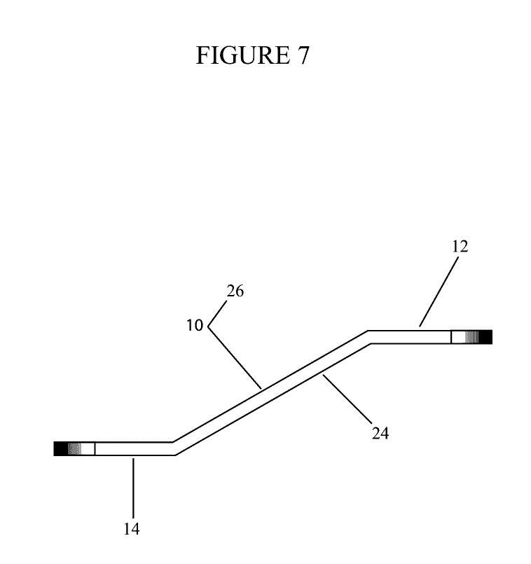

FIG. 7 illustrates the breakthrough of light lures adapted to fly fishing techniques. By making the lure of lighter or thinner material, the fly lure body 26 can be cast primarily with the weight of the fly line and not the weight of the lure. Since fly fisherman are a dedicated and growing segment of the fishing community, this should be the leader of a number of existing lures adapted to fly fishing techniques. But, it is very doubtful if any will achieve the results of the “angle bar lure”, because it is balanced symmetrically and the action of very light weight fly-lures will be enhanced by the action of stream currents, and/or the tantalizing slower movement in lakes. Trout are generally adapted to feeding on insect life and thus are accustomed to the slow movement of insect larvae and other common food such as leeches.

All of the actions created by the balanced and symmetrical design will be emulated in the “fly-lure” adaptation. The differences will be in slower sink rates and exaggerated movements, but at a slower pace.

The angle bar lure, in smaller sizes and lighter weights, will almost assuredly revolutionize the use of lures in fly fishing situations and methods.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An angle bar fishing lure for maximizing the variety of lure motions and actions, comprising:
means for connecting equal front and rear portions with angled mid-section;
means for providing a flat portion that causes the lure to have an erratic action, rigidly connected to said means for connecting equal front and rear portions with angled mid-section;
means for balancing the front portion allowing both to cause the lure body to move erratically, rigidly connected to said means for connecting equal front and rear portions with angled mid-section;
means for providing resistance, creating a wide variety of lure actions, rigidly connected to said means for balancing the front portion allowing both to cause the lure body to move erratically, and rigidly connected to said means for providing a flat portion that causes the lure to have an erratic action;
means for connecting the swivel to the front of the lure, rotationally connected to said means for providing a flat portion that causes the lure to have an erratic action;
means for allowing the lure to turn over and reverse the movement from the front to rear sections, rotationally connected to said means for connecting the swivel to the front of the lure; and
means for allowing the lure to be cast with a fly rod using the weight of the line, not the fly-lure, independently connected to said means for connecting equal front and rear portions with angled mid-section.

2. The angle bar fishing lure in accordance with claim 1, wherein said means for connecting equal front and rear portions with angled mid-section comprises a lure body.

3. The angle bar fishing lure in accordance with claim 1, wherein said means for providing a flat portion that causes the lure to have an erratic action comprises a front section.

4. The angle bar fishing lure in accordance with claim 1, wherein said means for balancing the front portion allowing both to cause the lure body to move erratically comprises a rear section.

5. The angle bar fishing lure in accordance with claim 1, wherein said means for providing resistance, creating a wide variety of lure actions comprises a different angle angled mid-section.

6. The angle bar fishing lure in accordance with claim 1, wherein said means for connecting the swivel to the front of the lure comprises a front split ring.

7. The angle bar fishing lure in accordance with claim 1, wherein said means for allowing the lure to turn over and reverse the movement from the front to rear sections comprises a swivel.

8. The angle bar fishing lure in accordance with claim 1, wherein said means for allowing the lure to be cast with a fly rod using the weight of the line, not the fly-lure comprises a thin body fly lure body.

9. An angle bar fishing lure for maximizing the variety of lure motions and actions, comprising:
a lure body, for connecting equal front and rear portions with angled mid-section;
a front section, for providing a flat portion that causes the lure to have an erratic action, rigidly connected to said lure body;
a rear section, for balancing the front portion allowing both to cause the lure body to move erratically, rigidly connected to said lure body;
a different angle angled mid-section, for providing resistance, creating a wide variety of lure actions, rigidly connected to said rear section, and rigidly connected to said front section;
a front split ring, for connecting the swivel to the front of the lure, rotationally connected to said front section;
a swivel, for allowing the lure to turn over and reverse the movement from the front to rear sections, rotationally connected to said front split ring; and
a thin body fly lure body, for allowing the lure to be cast with a fly rod using the weight of the line, not the fly-lure, independently connected to said lure body.

10. The angle bar fishing lure as recited in claim 9, further comprising:
a rear split ring, for connecting the hook to the lure, rotationally connected to said rear section.

11. An angle bar fishing lure for maximizing the variety of lure motions and actions, comprising:
a lure body, for connecting equal front and rear portions with angled mid-section;
a front section, for providing a flat portion that causes the lure to have an erratic action, rigidly connected to said lure body;
a rear section, for balancing the front portion allowing both to cause the lure body to move erratically, rigidly connected to said lure body;
a different angle angled mid-section, for providing resistance, creating a wide variety of lure actions, rigidly connected to said rear section, and rigidly connected to said front section;
a front split ring, for connecting the swivel to the front of the lure, rotationally connected to said front section;
a swivel, for allowing the lure to turn over and reverse the movement from the front to rear sections, rotationally connected to said front split ring;
a rear split ring, for connecting the hook to the lure, rotationally connected to said rear section; and
a thin body fly lure body, for allowing the lure to be cast with a fly rod using the weight of the line, not the fly-lure, independently connected to said lure body.
